(19) United States
(12) Patent Application Publication
(10) Pub. No.: US 2024/0376759 A1
(43) Pub. Date: Nov. 14, 2024

(54) SHAFT COVER FOR A QUIET GARAGE DOOR HINGE

(71) Applicant: ASSA ABLOY Entrance Systems AB, Landskrona (SE)

(72) Inventors: Rony Gracius, Overland Park, KS (US); John David Amundson, JR., Olathe, KS (US)

(21) Appl. No.: 18/196,714

(22) Filed: May 12, 2023

(51) Int. Cl. E05D 15/24

(52) U.S. Cl. CPC E05D 15/242; E05Y 2201/48; E05Y 2201/688; E05Y 2800/422; E05Y 2800/676; E05Y 2900/106

(57) ABSTRACT

A hinge for operably coupling panels of a garage door may include a first leaf assembly, a second leaf assembly, a tubular pivot support operably coupling the first leaf assembly to the second leaf assembly, a shaft cover, and a roller assembly. The roller assembly may include a roller and a shaft. The shaft may be configured to pass through the tubular pivot support with the shaft cover disposed between the shaft and the tubular pivot support. The shaft cover may include a substantially cylindrically shaped shaft cover body extending from a first axial end to a second axial end of the shaft cover, and a relief slot formed in the shaft cover body extending from the first axial end to the second axial end.

### TECHNICAL FIELD

Example embodiments generally relate to garage door hinges and, in particular, relate to a quiet hinge employing a self-lubricating shaft cover that fits multiple hinge designs with variations in design tolerances.

### BACKGROUND

Many garage doors are formed from a series of panels that are connected to each other via hinges. These panels are also often supported in a track assembly to be movable up and down the track assembly to alternately open and close the doors via rollers. Hinges at internal portions of the panels (i.e., portions spaced apart from lateral edges where the rollers are located) may be relatively simple in construction including a leaf assembly attached to each respective door panel, and a hinge pin or shaft that operably couples the leaf assemblies via insertion into a tubular pivot support that is operably coupled to both leaf assemblies. Meanwhile, hinges at the lateral edges of the panels may be similar to the aforementioned hinges except that the shaft may incorporate a roller at an end of the shaft that extends toward the track assembly.

This relatively simple construction may, in some cases, suffer from metal on metal contact between the shaft and the tubular pivot support. The metal on metal contact may cause wear that leads to a need for part replacement over time, but also generates a relatively high amount of noise, which may be bothersome to the owners of the garage doors. To address these issues, a self-lubricated sleeve may be inserted into the tubular pivot support between the shaft and the tubular pivot support. Such a self-lubricated sleeve is described, for example, in U.S. Pat. Nos. 9,394,734 and 6,718,595.

These self-lubricated sleeves are generally very good for their intended purpose. However, since hinges are often mass produced and the components thereof may be made by multiple manufacturers, there are inevitably differences in design tolerances and manufacturing accuracies among manufacturers, and among individual hinge components, which can lead to variances in certain component measurements. One such component where variances may be experienced is the tubular pivot support pivot. For example, in some cases the tubular pivot support may be a cylindrical component manufactured with very tight tolerances and consistent shape and internal diameter between respective parts. However, in other cases, the tubular pivot support may simply be a piece of metal roll formed into the shape of a cylinder, but the rolling process may be somewhat inexact and instead of a perfect cylinder, the result may be slightly oval in cross sectional shape. Moreover, there may be differences in the degree to which individual parts are more oval than round. These differences may be addressed by ordering custom hinges that are made with more exacting parameters. However, that may increase cost substantially, and therefore a better solution is desirable.

### BRIEF SUMMARY OF SOME EXAMPLES

In an example embodiment, a shaft cover for lubricating a hinge of a garage door may be provided. The hinge may include a first leaf assembly, a second leaf assembly, a tubular pivot support operably coupling the first leaf assembly to the second leaf assembly, and a roller assembly comprising a roller and a shaft. The shaft cover may include a first axial end, a second axial end, a substantially cylindrically shaped shaft cover body extending from the first axial end to the second axial end, and a relief slot formed in the shaft cover body extending from the first axial end to the second axial end. The shaft cover may be configured for insertion between the shaft and the tubular pivot support.

In another example embodiment, a hinge for operably coupling panels of a garage door may be provided. The hinge may include a first leaf assembly, a second leaf assembly, a tubular pivot support operably coupling the first leaf assembly to the second leaf assembly, a shaft cover, and a roller assembly. The roller assembly may include a roller and a shaft. The shaft may be configured to pass through the tubular pivot support with the shaft cover disposed between the shaft and the tubular pivot support. The shaft cover may include a substantially cylindrically shaped shaft cover body extending from a first axial end to a second axial end of the shaft cover, and a relief slot formed in the shaft cover body extending from the first axial end to the second axial end substantially parallel to an axial centerline of the shaft cover body.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a hinge for a garage door in accordance with an example embodiment;

FIG. 2 shows a perspective view of the hinge with a roller assembly installed in accordance with an example embodiment;

FIG. 3 illustrates an exploded view of the hinge of FIG. 2 according to an example embodiment;

FIG. 4 shows a perspective view of a roller assembly in isolation according to an example embodiment;

FIG. 5 illustrates an isolated perspective view of a shaft cover with a relief slot according to an example embodiment;

FIG. 6 illustrates a cross section view of the shaft cover of FIG. 5 in accordance with an example embodiment; and

FIG. 7 illustrates a garage door employing multiple instances of a hinge in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, it may be desirable to design a shaft cover that is capable of providing quiet hinge operation with a wide range of hinge designs. Example embodiments are aimed at doing just that. In this regard, regardless of the hinge manufacturer, or the method of manufacturing, example embodiments may provide an ability to handle tolerance variation in the shape and size of the tubular pivot support and still provide reduction in metal wear, door vibration and noise. In particular, by providing a relief slot that extends axially along the shaft cover, the relief slot enables the shape of the shaft cover to conform better to the shape and size of the tubular pivot support. As a result, whereas a perfectly round and completely tubular shaft sleeve may potentially not fit in certain tubular pivot supports, or may have to be deformed in order to fit, the relief slot enables the shaft cover of example embodiments to reliably and flexibly conform to the shape and size of the hinge tubular pivot support. Moreover, when deformed or otherwise placed into an odd shaped or sized tubular pivot support, a conventional perfectly round and completely tubular shaft sleeve may have forces concentrated thereon in certain places that may reduce the life of the shaft sleeve and consequently also result in earlier need for replacement and ultimately more noise, vibration and metal on metal contact. All of this is avoided with the relief slot formed in the shaft cover, as well as the potential need to order custom hinges that are designed with high accuracy to have perfectly round tubular pivot supports. Not only is superior performance therefore achieved, but such superior performance is achieved at a lower cost instead of actually increasing cost to solve the problem being addressed. In this regard, the cost increase (if any) associated with providing the relief slot in the shaft cover (relative to the cost of a perfectly round and completely tubular shaft sleeve) is far less than the cost of avoiding the problems of noise and vibration that otherwise occur when shifting from the varied shape and size of the tubular pivot support of a commodity hinge to that of a higher cost custom hinge, which has less tolerance variation.

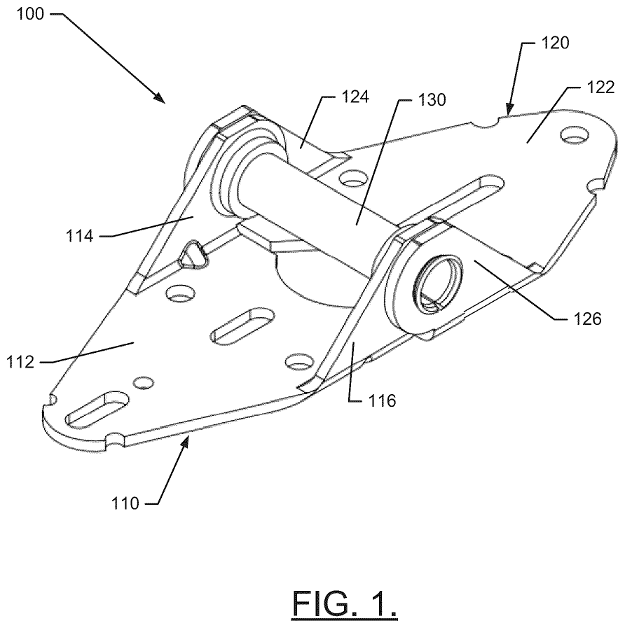

FIG. 1 illustrates a hinge 100 according to an example embodiment in an assembled state. The hinge includes a first leaf assembly 110 and a second leaf assembly 120. The first leaf assembly 110 includes a first base portion 112, a first support wall 114 and a second support wall 116. The first and second support walls 114 and 116 are formed on opposing lateral sides of the first base portion 112, and extend substantially perpendicularly away from the first base portion 112 while being substantially parallel to each other. The second leaf assembly 120 includes a second base portion 122, a third support wall 124 and a fourth support wall 126. The third and fourth support walls 124 and 126 are formed on opposing lateral sides of the second base portion 122, and extend substantially perpendicularly away from the second base portion 122 while being substantially parallel to each other.

A tubular pivot support 130 may be formed to extend between the first and third support walls 114 and 124 at one end of the tubular pivot support 130 and the second and fourth support walls 116 and 126 at an opposite end of the tubular pivot support 130. In this regard, in some embodiments each of the first, second, third and fourth support walls 114, 116, 124 and 126 may include an orifice formed therein, and the tubular pivot support 130 may pass through each of these orifices. In such an example, the tubular pivot support 130 may be a separately formed hollow cylinder that passes through the orifices, and may include a flange at least at one end thereof to prevent the tubular pivot support 130 from passing through the orifices and falling out. As an alternative, the tubular pivot support 130 could be roll formed from a longitudinal end portion of one of the first or second base portions 112 and 122. In such an example, the support walls of the corresponding one of the base portions from which the tubular pivot support 130 is roll formed may be omitted.

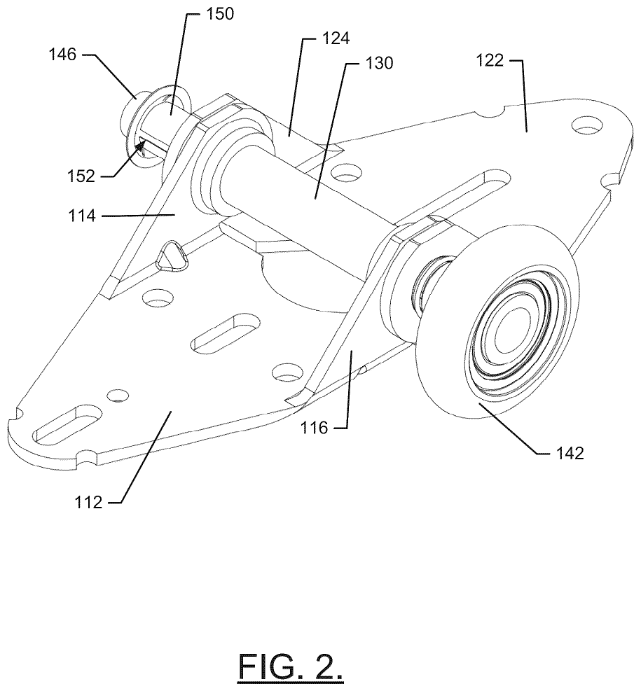

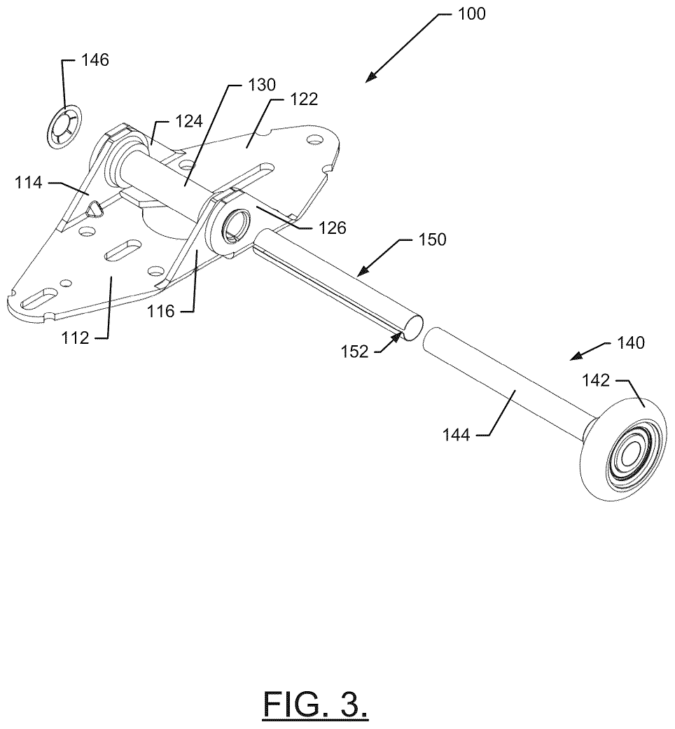

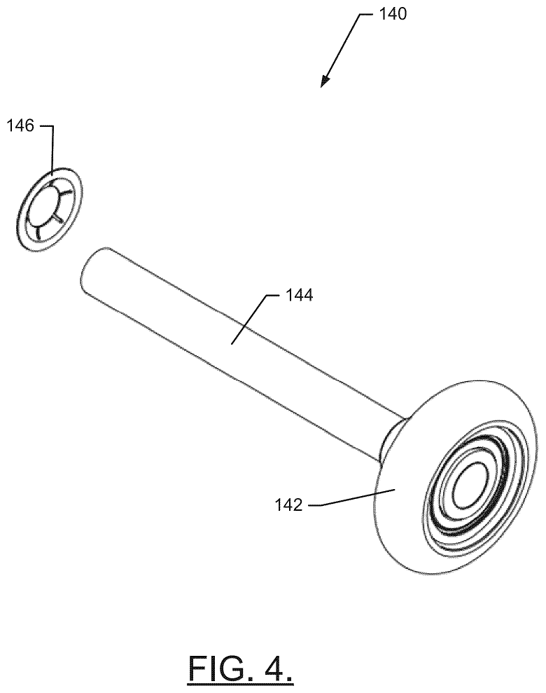

The first base portion 112 may be fastened to a first panel of a garage door, and the second base portion 122 may be fastened to a second panel of a garage door. Moreover, multiple instances of hinges may be employed along the first and second panels to connect the first and second panels together and allow the first and second panels to bend in relation to each other as the garage door transitions between open and closed positions. When such hinges are placed at the intersection of the first and second panels at opposing lateral ends thereof, a roller assembly 140 may be employed to allow the roller assembly 140 to carry the garage door along tracks in which the garage door travels between the open and closed positions. FIGS. 2 and 3 illustrate the incorporation of the roller assembly 140 of an example embodiment, and FIG. 4 illustrates the roller assembly 140 itself in isolation.

Referring to FIGS. 2-4, the roller assembly 140 may include a roller 142 that is rotatably coupled to a shaft 144 at a first end of the shaft 144. The first end of the shaft 144 may be disposed on an opposite side of the hinge 100 relative to the center of the garage door. In some embodiments, a second end of the shaft 144 may be passed through the tubular pivot support 130 and a push nut 146 may be operably coupled to the second end of the shaft 144 to ensure that the shaft 144 does not withdraw from the tubular pivot support 130.

In basic terms, the components described above may present a fully operational instance of the hinge 100. However, if left in this form, as also noted above, there would be metal on metal contact between the shaft 144 and the inside of the tubular pivot support 130. To provide lubrication (or self-lubrication), previous conventional hinges would typically provide a shaft sleeve to insert between the shaft 144 and the tubular pivot support 130. This shaft sleeve, as noted above, is tubular in shape (i.e., a hollow cylinder with a circular cross section), and is not amenable to employment in some instances of the tubular pivot support 130 (particularly when the tubular pivot support 130 is not perfectly round, or at least within a close range of being perfectly round).

To cure this deficiency, example embodiments employ a shaft cover 150 having a relief slot 152 formed to extend along an entire axial length of the shaft cover 150. The shaft cover 150 may be inserted between the hinge tubular support 130 and the shaft 144, and may provide self-lubrication of the hinge 100. In some embodiments, the shaft cover 150 may be slightly shorter than the shaft 144 in order to enable the push nut 146 to fit on the second end of the shaft 144. When the push nut 146 is installed, in some cases the push nut 146 may be proximate to a first axial end of the shaft cover 150. The second axial end of the shaft cover 150 may be proximate to the roller 142. Thus, it may be appreciated that the shaft cover 150 has a length longer than a length of the tubular pivot support 130, but shorter than a length of the shaft 144.

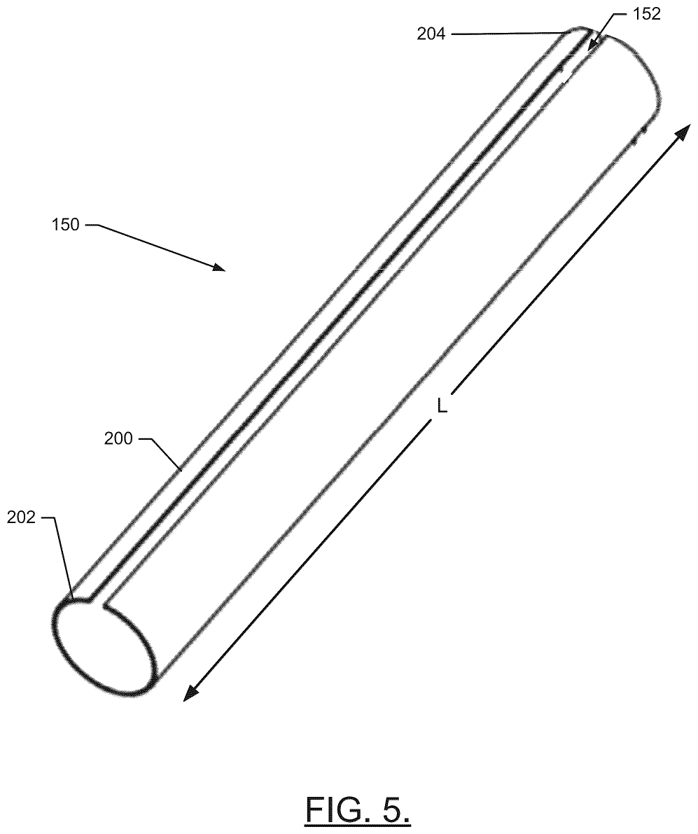

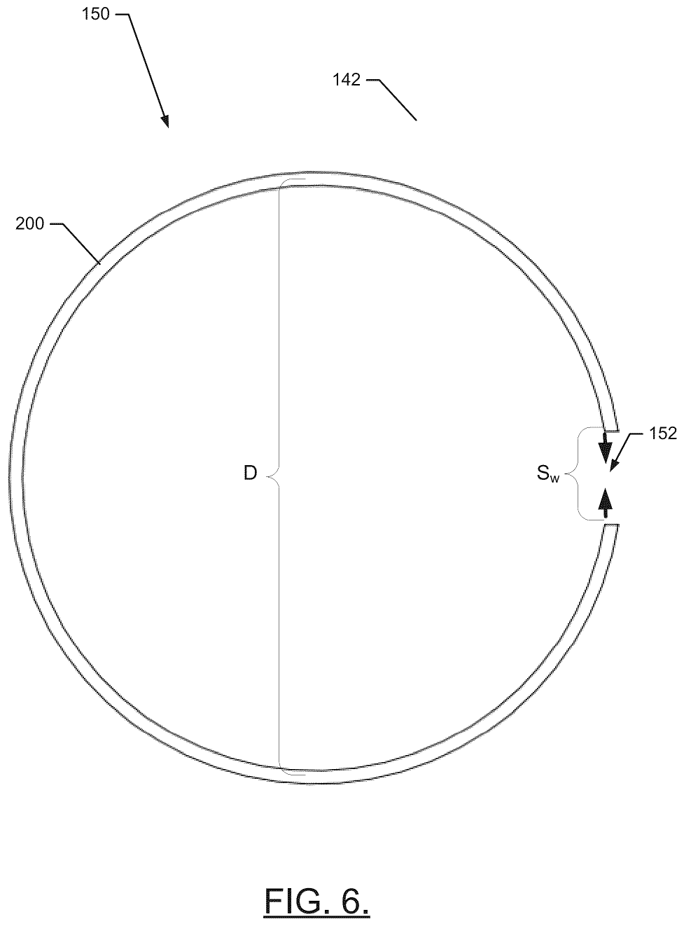

The shaft cover 150 is fully visible in the exploded view of FIG. 3, but is also shown in its installed position with the first axial end exposed and proximate to the push nut 146 in FIG. 2. Meanwhile, FIG. 5 shows a perspective view of the shaft cover 150 in isolation, and FIG. 6 illustrates a cross section view of the shaft cover 150. As shown particularly in FIGS. 5 and 6, the shaft cover 150 may include a shaft cover body 200, which may be formed by drawing or extrusion of a thermoplastic polymer or nylon material. Thus, for example, the shaft cover body 200 may be extruded to include the relief slot 152 by forming a gap in the shaft cover body 200 via the die used to form the shaft cover body 200. However, in some cases the shaft cover body 200 may be formed using a jig and fixture, with two parallel blades to cut the relief slot 152. The shaft cover body 200 may have a length (L) extending from a first axial end 202 to a second axial end 204, which may be interchangeable. In other words, the shaft cover body 200 may be symmetrical about a plane passed through its midpoint in length (L). The shaft cover body 200 may also have a diameter (D), which may be a consistent value from the first axial end 202 to the second axial end 204 (i.e., along an entirety of length (L)). In an example embodiment, the diameter (D) may be about 0.44 inches, and the length (L) may be about 3.5 inches. A thickness of the shaft cover body 200 may be about 0.01 inches.

The relief slot 152 may extend in a straight line from the first axial end 202 to the second axial end 204, and may be parallel to an axis of the shaft cover 150, and define a C-shaped cross section for the shaft cover body 200. In an example embodiment, a slot width (S_{w}) of the relief slot 152 may be in a range from about 0.07 inches (i.e., 1.78 mm) to about 0.3 inches (i.e., 7.62 mm). However, in some cases, the lower end of the range could be as small as 1 mm. A maximum width of the relief slot 152 to maintain effectiveness thereof may be about 8 mm. In other words, for a slot width (S_{w}) any larger than 8 mm, the possibility of metal on metal contact may be too large to ensure a benefit to the use of the shaft cover 150.

By providing the relief slot 152 in the shaft cover body 200, the shaft cover body 200 may flex (e.g., inward in directions shown by arrows in FIG. 6) responsive to insertion into an instance of the tubular pivot support 130 that is out-of-round. The shaft cover 150, with improved fit in a non-concentric tubular pivot support, may provide effective self lubrication for the hinge 100 so that metal-on-metal situations, vibration, noise, etc., are all avoided. In other words, if the tubular pivot support 130 is shaped such that it is not concentric with the shaft 144, the shaft cover 150 of an example embodiment can mitigate the lack of concentricity by flexing to fit within the out-of-round space, without sacrificing any loss of performance. Thus, the shaft cover 150, by virtue of including the relief slot 152, may fit multiple hinges having different tolerance variations and therefore also potentially different shapes (i.e., degrees of being out-of-round). The ability of the relief slot 152 to enable fitting with, and functional and effective lubrication of, multiple hinge designs (with corresponding variations in parameters such as diameter (e.g., roundness and consistency)) may, as noted above, enable lower cost commodity hinges to be used in quiet hinge applications without sacrificing performance. Meanwhile, if the tubular pivot support 130 is perfectly round, the performance of the shaft cover 150 will be indistinguishable from the perfectly round shaft sleeve of conventional hinge designs. As such, example embodiments provide the same performance for hinges that happen to have tubular pivot supports that are in-round as the conventional round shaft sleeve, but provide superior performance in instances where the hinge includes a tubular pivot support that is some amount of out-of-round.

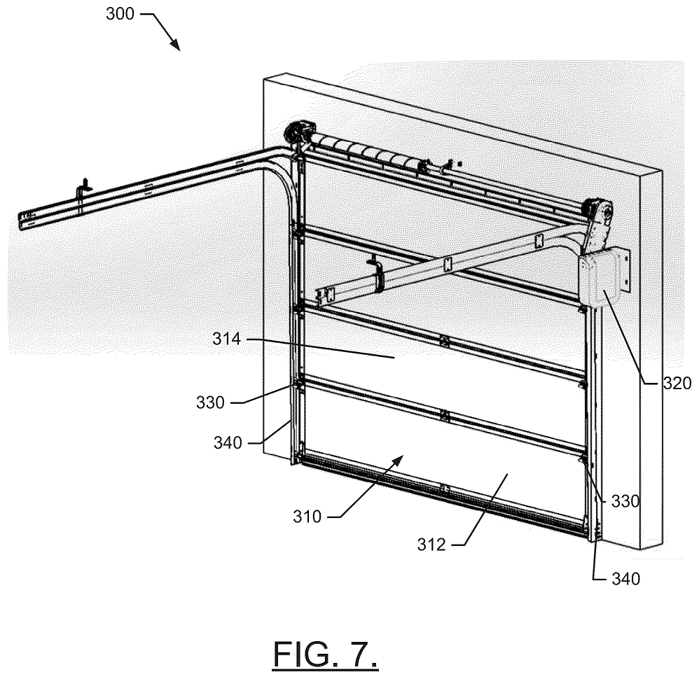

FIG. 7 illustrates a garage door system 300 including a garage door 310 and a garage door opener 320 that is operably coupled to the garage door 310 to alternately open and close the garage door 310. The garage door 310 may be a sectional door including at least a first panel 312 and a second panel 314 that are operably coupled to each other via respective instances of a hinge 330. The hinges 330 shown at lateral ends of the first and second panels 312 and 314 may be examples of the hinge 100 described above.

The garage door system 300 further includes rails 340 disposed on opposing sides of the garage door 310 as the garage door 310 transitions between open and closed positions responsive to operation of the garage door opener 320 to drive rollers through the rails 340 as the garage door 310 transitions. The garage door 310 of FIG. 7 is shown in the closed position, where the rollers of the hinges 330 are in a vertical section of the rails 340. Thus, it can be appreciated that in the open position the rollers of the hinges 330 are located in a horizontally extending portion of the rails 340.

Accordingly, some example embodiments may provide a hinge having a shaft cover (or simply the shaft cover itself). The hinge may include a first leaf assembly and a second leaf assembly operably coupled to each other via a tubular pivot support. The hinge may further include a roller assembly comprising a roller and a shaft. The shaft may pass through the tubular pivot support and the shaft cover may be disposed between the shaft and the tubular pivot support. The shaft cover may include substantially cylindrically shaped shaft cover body extending from a first axial end to a second axial end, and a relief slot formed in the shaft cover body extending from the first axial end to the second axial end and, in some cases, may be substantially parallel to the axial centerline of the shaft cover body.

The shaft cover and/or a hinge including the same, or components thereof described above may be augmented or modified by altering individual features mentioned above or adding optional features. The augmentations or modifications may be performed in any combination and in any order. For example, in some cases, the shaft cover body may be made from a thermoplastic polymer. In an example embodiment, the shaft cover body may have a length of about 3.5 inches and a diameter of about 0.44 inches. In some cases, the shaft cover body may have a thickness of about 0.01 inches. In an example embodiment, the shaft cover body may be formed by extrusion with a die for forming a gap for the relief slot. In some cases, the relief slot may have a slot width measured between opposing ends of the shaft cover body that is less than about 0.315 inches. In an example embodiment, the relief slot may have a slot width measured between opposing ends of the shaft cover body that is between about 0.07 inches and about 0.3 inches. In some cases, the tubular pivot support may be a separately formed cylindrical tube. In an example embodiment, the first leaf assembly may include a first base portion, a first support wall and a second support wall where the first and second support walls are provided on opposing lateral sides of the first base portion, and extend substantially perpendicularly away from the first base portion while being substantially parallel to each other. The second leaf assembly may include a second base portion, a third support wall and a fourth support wall where the third and fourth support walls are provided on opposing lateral sides of the second base portion, and extend substantially perpendicularly away from the second base portion while being substantially parallel to each other. The tubular pivot support may extend through a corresponding orifice in each of the first, second, third and fourth support walls.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A hinge for operably coupling panels of a garage door, the hinge comprising:
a first leaf assembly;
a second leaf assembly;
a tubular pivot support operably coupling the first leaf assembly to the second leaf assembly;
a shaft cover; and
a roller assembly,
wherein the roller assembly comprises a roller and a shaft, the shaft being configured to pass through the tubular pivot support with the shaft cover disposed between the shaft and the tubular pivot support, and
wherein the shaft cover includes a substantially cylindrically shaped shaft cover body extending from a first axial end to a second axial end of the shaft cover, and a relief slot formed in the shaft cover body extending from the first axial end to the second axial end.

2. The hinge of claim 1, wherein the shaft cover body is a thermoplastic polymer.

3. The hinge of claim 2, wherein the shaft cover body has a length of about 3.5 inches and a diameter of about 0.44 inches.

4. The hinge of claim 2, wherein the shaft cover body has a thickness of about 0.01 inches.

5. The hinge of claim 2, wherein the shaft cover body is formed by extrusion with a die for forming a gap for the relief slot.

6. The hinge of claim 2, wherein the relief slot has a slot width measured between opposing ends of the shaft cover body that is less than about 0.315 inches.

7. The hinge of claim 2, wherein the relief slot has a slot width measured between opposing ends of the shaft cover body that is between about 0.07 inches and about 0.3 inches.

8. The hinge of claim 1, wherein the tubular pivot support is a separately formed cylindrical tube.

9. The hinge of claim 8, wherein the first leaf assembly comprises a first base portion, a first support wall and a second support wall, the first and second support walls being provided on opposing lateral sides of the first base portion, and extend substantially perpendicularly away from the first base portion while being substantially parallel to each other,
wherein the second leaf assembly comprises a second base portion, a third support wall and a fourth support wall, the third and fourth support walls being provided on opposing lateral sides of the second base portion, and extend substantially perpendicularly away from the second base portion while being substantially parallel to each other, and
wherein the tubular pivot support extends through a corresponding orifice in each of the first, second, third and fourth support walls.

10. The hinge of claim 1, wherein the tubular pivot support is formed of rolled metal of an integral portion of one of the first leaf assembly or the second leaf assembly.

11. The hinge of claim 1, wherein the shaft cover has a length longer than a length of the tubular pivot support, but shorter than a length of the shaft.

12. The hinge of claim 1, wherein the relief slot is formed in the shaft cover body extending from the first axial end to the second axial end substantially parallel to an axial centerline of the shaft cover body.

13. A shaft cover for lubricating a hinge of a garage door, the hinge comprising a first leaf assembly, a second leaf assembly, a tubular pivot support operably coupling the first leaf assembly to the second leaf assembly, and a roller assembly comprising a roller and a shaft, the shaft cover comprising:
a first axial end;
a second axial end;
a substantially cylindrically shaped shaft cover body extending from the first axial end to the second axial end; and
a relief slot formed in the shaft cover body extending from the first axial end to the second axial end, the shaft cover being configured for insertion between the shaft and the tubular pivot support.

14. The shaft cover of claim 13, wherein the shaft cover body is a thermoplastic polymer.

15. The shaft cover of claim 14, wherein the shaft cover body has a length of about 3.5 inches and a diameter of about 0.44 inches.

16. The shaft cover of claim 14, wherein the shaft cover body has a thickness of about 0.01 inches.

17. The shaft cover of claim 14, wherein the shaft cover body is formed by extrusion with a die for forming a gap for the relief slot.

18. The shaft cover of claim 14, wherein the relief slot has a slot width measured between opposing ends of the shaft cover body that is less than about 0.315 inches.

19. The shaft cover of claim 14, wherein the relief slot has a slot width measured between opposing ends of the shaft cover body that is between about 0.07 inches and about 0.3 inches.

20. The shaft cover of claim 13, wherein the relief slot is formed in the shaft cover body extending from the first axial end to the second axial end substantially parallel to an axial centerline of the shaft cover body.
